(19) United States
(12) Patent Application Publication
(10) Pub. No.: US 2025/0069426 A1
(43) Pub. Date: Feb. 27, 2025

(54) PROVIDING IMPROVED OPTICAL CHARACTER RECOGNITION USING AN AUTOMATIC METRIC-BASED EVALUATION PLATFORM

(71) Applicant: Bank of America Corporation, Charlotte, NC (US)

(72) Inventors: Harshit Rohela, Moradabad (IN); Donna M. Welch, Bluffton, SC (US); Kakarala Srinivasu, Hyderabad (IN); Jino Mathew, Wootton (GB); Mohan Singh, New Delhi (IN)

(21) Appl. No.: 18/237,932

(22) Filed: Aug. 25, 2023

(51) Int. Cl. G06V 30/19; G06V 30/12; G06V 30/24

(52) U.S. Cl. CPC G06V 30/19113; G06V 30/133; G06V 30/248

(57) ABSTRACT

Aspects of the disclosure relate to providing improved optical character recognition (OCR). An OCR evaluation platform may generate a script for evaluating OCR performance. The platform may generate modified resources by executing OCR applications to modify original resources. Based on executing the script, the platform may generate comparative analysis information based on comparing the modified resources to the original resource. The platform may generate metric scores based on the comparative analysis information. The metric scores may be used to generate visual representations of the performance of different OCR applications. The platform may generate weighted scores representing the performance of different OCR applications. The platform may identify a preferred OCR application for performing a particular operation. The platform may store correlations between preferred OCR applications and corresponding operations. The platform my cause execution of preferred OCR applications when performing corresponding operations, based on the stored correlations.

### BACKGROUND

In some instances, a system may use optical character recognition (OCR) technology to recognize text within a digital image. For example, OCR technology is commonly used to recognize text in scanned documents and images. There are many different OCR applications available for use, each of which may be better suited for performing one operation over another (e.g., performing OCR operations on a particular file type, or the like). Some systems implement performance metrics to evaluate the performance of a particular OCR application. However, in some examples, some of these metrics may be more relevant than others. Additionally or alternatively, in some instances, evaluating the performance of a particular OCR application may require significant user input and/or may provide limited information. Current methods of evaluating OCR applications use limited information (e.g., an evaluation of a limited number of metrics, an evaluation of a limited number of OCR applications, and/or other limited information) which may provide inefficient evaluation of OCR applications, which may in turn lead to inefficient use of OCR applications for particular operations. Accordingly, there exists a need to provide an improved method of performing OCR operations using metric-based evaluations.

### SUMMARY

Aspects of the disclosure provide effective, efficient, scalable, and convenient technical solutions that address and overcome the technical problems associated with current script generation procedures to facilitate information transfer. In accordance with one or more arrangements of the disclosure, a computing device with at least one processor, a communication interface, and memory storing computer-readable instructions may generate a script for evaluating performance of an optical character recognition (OCR) application. The script may be configured to output metric scores based on comparing original resources to modified resources. The computing platform may retrieve an original resource from a resource repository. The computing platform may generate a first modified resource by executing a first OCR application on the original resource. The computing platform may generate a second modified resource by executing a second OCR application, different from the first OCR application, on the original resource. The computing platform may execute the script for the first OCR application and the second OCR application.

Executing the script for the first OCR application and the second OCR application may include generating first comparative analysis information for the first OCR application by comparing the original resource to the first modified resource. Executing the script for the first OCR application and the second OCR application may include generating second comparative analysis information for the second OCR application by comparing the original resource to the second modified resource. Executing the script for the first OCR application and the second OCR application may include generating, based on the first comparative analysis information, one or more metric scores for the first OCR application. Executing the script for the first OCR application and the second OCR application may include generating, based on the second comparative analysis information, one or more metric scores for the second OCR application. Executing the script for the first OCR application and the second OCR application may include generating, based on the one or more metric scores for the first OCR application, a first weighted score. Executing the script for the first OCR application and the second OCR application may include generating, based on the one or more metric scores for the second OCR application, a second weighted score. The computing platform may identify a preferred OCR application for use in a first operation based on comparing the first weighted score and the second weighted score. The computing platform may store a correlation between the first operation and the preferred OCR application at the resource repository.

In one or more examples, the computing platform may enhance at least one modified resource corresponding to a third OCR application based on a weighted score for a third OCR application and using at least one image-enhancement application. In one or more arrangements, the computing platform may generate one or more visual representations for the first OCR application using the script and based on the one or more metric scores for the first OCR application. The computing platform may output at least one visual representation of the one or more visual representations in a first format for the first OCR application.

In one or more examples, the computing platform may output the at least one visual representation in a second format different from the first format and based on receiving user input. In one or more arrangements, the first weighted score and the second weighted score may correspond to a file type of the original resource. In one or more examples, the computing platform may cause, based on a stored correlation, at least one of: execution of the preferred OCR application to perform the first operation by the computing platform, or execution of the preferred OCR application to perform the first operation by a user device different from the computing platform. In one or more arrangements, the computing platform may receive a request to perform the first operation. The computing platform may execute the preferred OCR application to perform the first operation based on a stored correlation. The computing platform may receive a request to perform a second operation different from the first operation. The computing platform may execute a third OCR application different from the preferred OCR application to perform the second operation.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for providing improved optical character recognition using an automatic metric-based evaluation platform in accordance with one or more example arrangements;

FIGS. 2A-2D depict an illustrative event sequence for providing improved optical character recognition using an automatic metric-based evaluation platform in accordance with one or more example arrangements;

FIGS. 3A-3C depict illustrative graphical user interfaces depicting interfaces used for providing improved optical character recognition using an automatic metric-based evaluation platform in accordance with one or more example arrangements; and

FIG. 4 depicts an illustrative method for providing improved optical character recognition using an automatic metric-based evaluation platform in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to providing improved optical character recognition using an automatic metric-based evaluation platform. Entities such as an enterprise organization (e.g., a financial institution, and/or other institutions) may utilize one or more systems that perform OCR operations. Systems that use OCR applications to perform OCR operations (e.g., performing OCR on particular documents, performing OCR on different file types, and/or other OCR operations) may use one or more different OCR applications for different OCR operations. In some instances, the enterprise organization may wish to optimize the efficiency of OCR operations by selecting the best OCR application for a given operation. In doing so, the enterprise organization may employ a system for evaluating OCR applications on particular performance metrics (e.g., character error rates, word error rates, simple and/or weighted ratios of misidentified characters, capture rates, and/or other metrics). However, for a particular operation, one or more metrics may be more relevant to the enterprise organization than others. Additionally, the enterprise organization (and/or a particular employee of the organization) may benefit from a method of evaluating multiple OCR applications in view of multiple metrics with minimal user input, to provide a comprehensive evaluation of the multiple OCR applications' performance of a particular OCR operation.

Accordingly, in some instances, entities such as the enterprise organization and/or other organizations/institutions may employ a platform for automatically evaluating the performance of multiple OCR applications on multiple performance metrics. For example, a script may be generated that provides comprehensive evaluations of multiple OCR applications. In some instances, an original resource (e.g., a document, digital file, and/or other resources) may be modified by multiple different OCR applications to generate a modified resource corresponding to each OCR application. The modified resources, original resources, and indicators (e.g., names, identifiers, and/or other indicators) of which OCR applications were used to generate the modified resources may serve as inputs to the script. The script may evaluate each OCR application's performance in generating the corresponding modified resource by whatever metrics a user (e.g., an employee of the enterprise organization, and/or other users) deem relevant (e.g., by comparing the modified resources to the original resources to identify discrepancies, and/or by other methods). Based on evaluating the OCR applications, a record and/or correlation of which OCR application performed highest on one or more metric scores may be generated. The record and/or correlation may be used to select which OCR application to use for different OCR operations and may, in some instances, cause one or more devices (e.g., user devices associated with employees of an enterprise organization, and/or other devices) to use the selected OCR application in the future.

Institutions may employ the methods of providing improved OCR as described above via computing devices (e.g., by automatically generating and executing a script as described above, and/or executing the script based on user input). In some instances, a device such as a computing platform may retrieve original resources from a repository of resources for use in evaluating OCR performance. Before executing the script, in some examples, the platform may perform OCR using one or more OCR applications designated for evaluation to create the modified resources. In some instances, the platform may execute the script described above for each OCR application designated for evaluation to generate metric scores for each OCR application. In some examples, a user of the platform (e.g., an employee of an enterprise organization, such as a financial institution and/or other institutions) may wish to view a visual representation of the OCR applications' performance. Accordingly, the script may also generate one or more visual representations of the metric scores for each OCR application. In some examples, a weighted score for each OCR application may be generated that combines and weights each metric score generated by the script based on its relevance to the user. Based on the metric scores and/or the weighted metric score, the platform may select (e.g., automatically, and/or based on user input) an OCR application to use for a particular OCR operation in the future, and may store the record/correlation as described above. These records/correlations may be used by one or more additional users to select OCR applications for different OCR operations (e.g., within a system managed by an enterprise organization). This may improve the efficiency of the OCR process by optimizing the execution of different OCR applications to different OCR operations. In some instances, the efficiency of the OCR process may be further improved by automatically and continuously or near-continuously executing the script such that the evaluations of the OCR applications are continuously or near-continuously updated.

These and various other aspects will be discussed more fully herein.

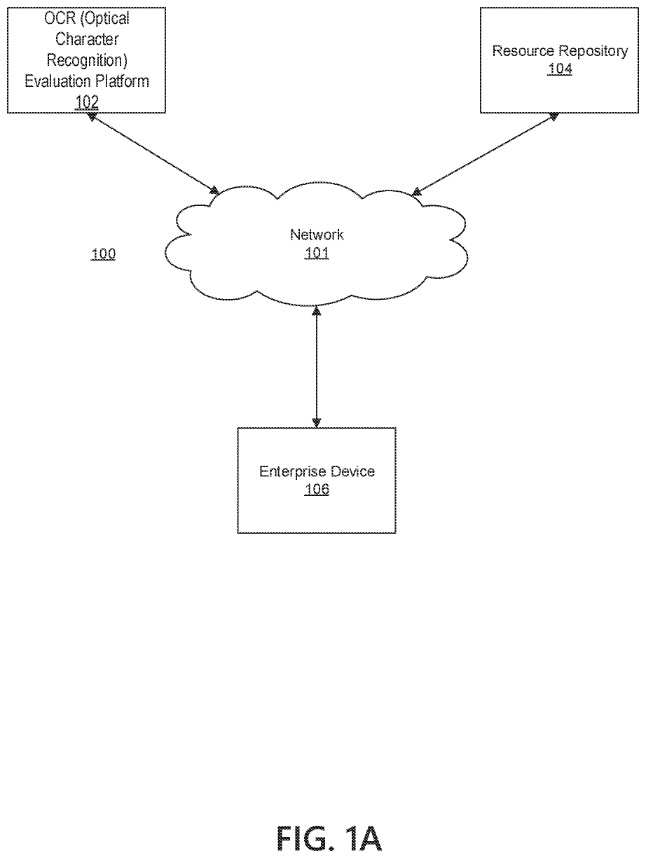

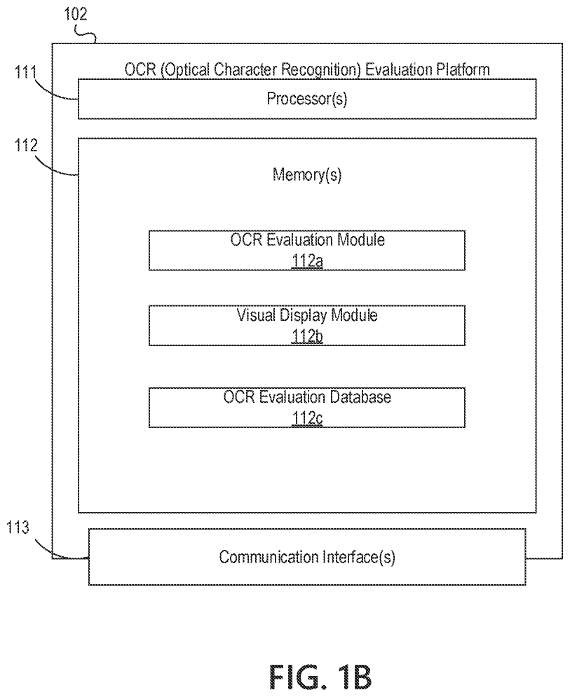

FIGS. 1A-1B depict an illustrative computing environment for providing improved optical character recognition (OCR) using an automatic metric-based evaluation platform in accordance with one or more example arrangements. Referring to FIG. 1A, computing environment 100 may include one or more computer systems. For example, computing environment 100 may include an OCR evaluation platform 102, a resource repository 104, and an enterprise device 106.

As described further below, OCR evaluation platform 102 may be a computer system that includes one or more computing devices (e.g., servers, laptop computers, desktop computers, mobile devices, tablets, smartphones, and/or other devices) and/or other computer components (e.g., processors, memories, communication interfaces) that may be used to implement methods for providing improved OCR using automatic metric-based evaluations. In some examples, a script for providing improved OCR using automatic metric-based evaluations may be written, coded, installed, and/or otherwise maintained by the OCR evaluation platform 102. For example, the script may be a program written by an employee of an enterprise organization (e.g., a financial institution, and/or other institutions). In some instances, OCR evaluation platform 102 may be a user device corresponding to a user (e.g., an employee of the enterprise organization, and/or other users). In one or more instances, the OCR evaluation platform 102 may be configured to communicate with one or more systems (e.g., resource repository 104, enterprise device 106, and/or other systems) to perform an information transfer, synchronize stored correlations, display visual representations, cause execution of an OCR application, and/or perform other functions. In some instances, the OCR evaluation platform 102 may be configured to display one or more graphical user interfaces (e.g., OCR performance interfaces, OCR visual metric interfaces, OCR visual display interfaces, and/or other interfaces).

The resource repository 104 may be and/or otherwise include one or more computing devices (e.g., servers, server blades, laptop computers, desktop computers, mobile devices, tablets, smartphones, and/or other devices) and/or other computer components (e.g., processors, memories, communication interfaces) that may be used to create, host, modify, and/or otherwise validate an organized collection of information (e.g., a resource database). The resource repository 104 may be synchronized across multiple nodes (e.g., sites, institutions, geographical locations, and/or other nodes) and may be accessible by multiple users (who may, e.g., be employees of an enterprise organization such as a financial institutions). The information stored at the resource repository 104 may include digital resources (e.g., scanned documents, text files, charts, video files, audio files, data tables, and/or other digital resources) and/or any additional information. In some instances, the resource repository 104 may be accessed by, validated by, and/or modified by any of, OCR evaluation platform 102, enterprise device 106, and/or other devices. Although shown as an independent database, in some instances, the resource repository 104 may be part of and/or otherwise integrated into the OCR evaluation platform 102 without departing from the scope of the disclosure.

Although only one resource repository is depicted herein, any number of such systems may be used to implement the methods described herein without departing from the scope of the disclosure

Enterprise device 106 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., accessing a resource repository, executing an OCR application, and/or other functions). In one or more instances, enterprise device 106 may correspond to a first user (who may, e.g., be an employee or client of the enterprise organization, such as a financial institution and/or other institution). In one or more instances, the enterprise device 106 may be configured to communicate with one or more systems (e.g., OCR evaluation platform 102, resource repository 104, and/or other systems) to perform a data transfer, access a stored correlation, execute an OCR application, and/or to perform other functions. In some instances, the enterprise device 106 may be configured to display one or more graphical user interfaces (e.g., OCR performance interfaces, OCR visual metric interfaces, OCR visual display interfaces, and/or other interfaces).

Computing environment 100 also may include one or more networks, which may interconnect OCR evaluation platform 102, resource repository 104, and enterprise device 106. For example, computing environment 100 may include a network 101 (which may interconnect, e.g., OCR evaluation platform 102, resource repository 104, and enterprise device 106).

In one or more arrangements, OCR evaluation platform 102, resource repository 104, and enterprise device 106 may be any type of computing device capable of sending and/or receiving requests and processing the requests accordingly. For example, OCR evaluation platform 102, resource repository 104, enterprise device 106, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of OCR evaluation platform 102, resource repository 104, and enterprise device 106, may, in some instances, be special-purpose computing devices configured to perform specific functions.

Referring to FIG. 1B, OCR evaluation platform 102 may include one or more processors 111, memory 112, and communication interface 113. An information bus may interconnect processor 111, memory 112, and communication interface 113. Communication interface 113 may be a network interface configured to support communication between OCR evaluation platform 102 and one or more networks (e.g., network 101, or the like). Communication interface 113 may be communicatively coupled to the processor 111. Memory 112 may include one or more program modules having instructions that, when executed by processor 111, cause OCR evaluation platform 102 to perform one or more functions described herein and/or one or more databases (e.g., an OCR evaluation database 112c, or the like) that may store and/or otherwise maintain information which may be used by such program modules and/or processor 111. In some instances, the one or more program modules and/or databases may be stored by and/or maintained in different memory units of OCR evaluation platform 102 and/or by different computing devices that may form and/or otherwise make up OCR evaluation platform 102. For example, memory 112 may have, host, store, and/or include an OCR evaluation module 112a, a visual display module 112b, and an OCR evaluation database 112c.

OCR evaluation module 112a may have instructions that direct and/or cause OCR evaluation platform 102 to generate modified resources, generate comparative analysis information, generate metric scores, store correlations between OCR applications and OCR operations, cause execution of an OCR application, enhance modified resources, and/or perform other OCR evaluation functions. Visual display module 112b may have instructions that direct and/or cause OCR evaluation platform 102 to generate visual displays, output visual displays, and/or perform other visual display functions. OCR evaluation database 112c may have instructions causing OCR evaluation platform 102 to store correlations between OCR applications and OCR operations. In some instances, OCR evaluation database 112c may be and/or include resource repository 104.

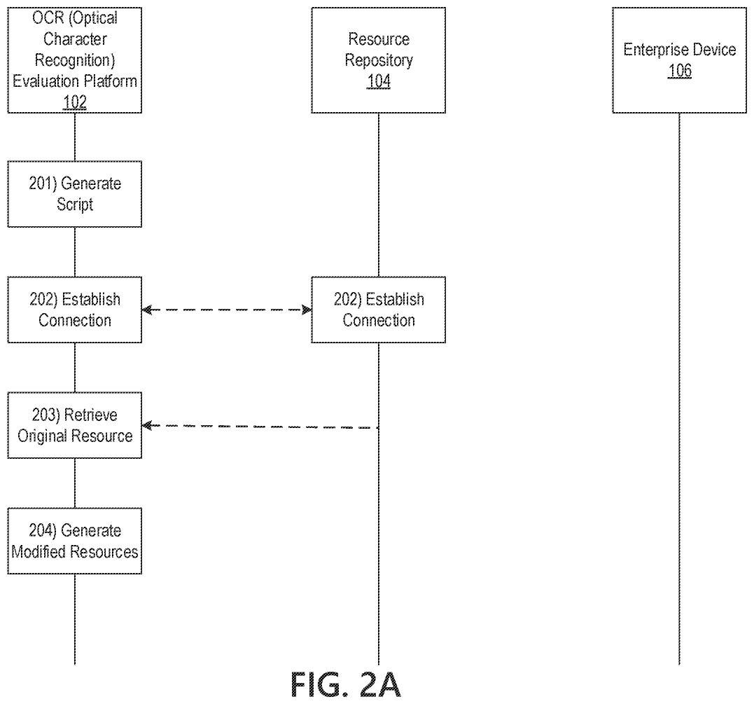

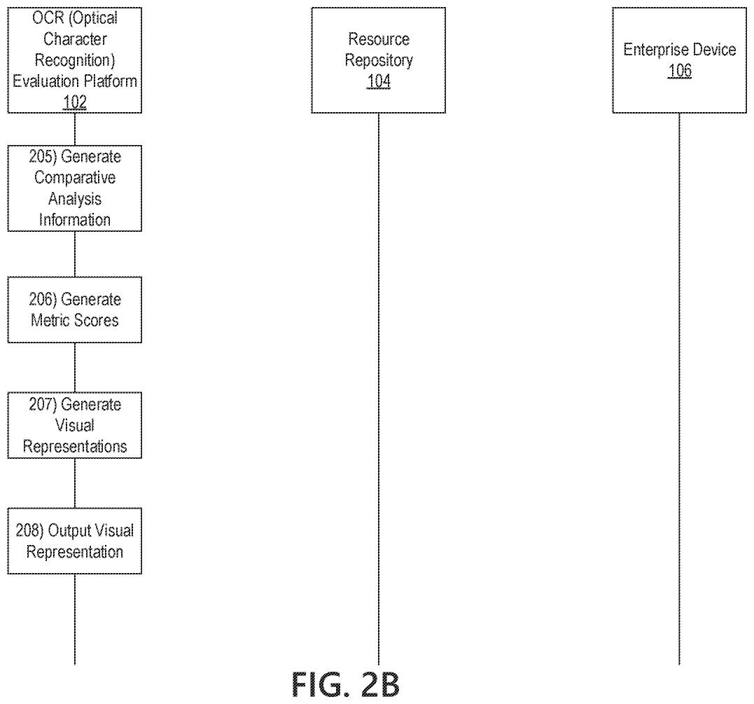

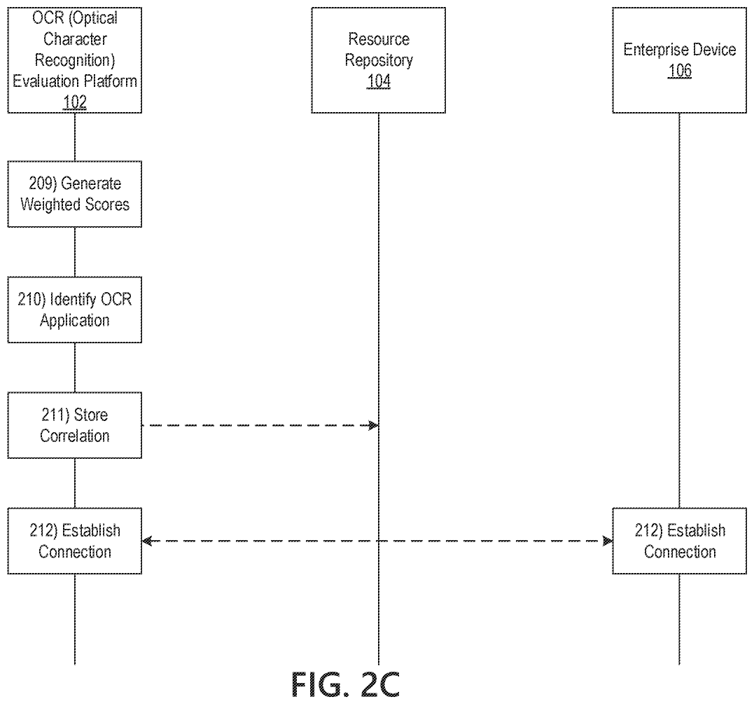

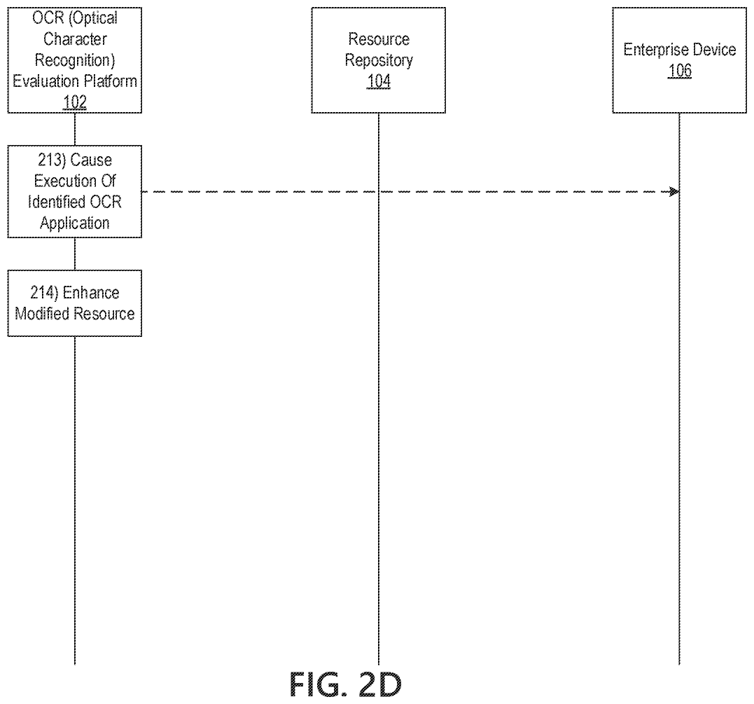

FIGS. 2A-2D depict an illustrative event sequence for providing improved optical character recognition using an automatic metric-based evaluation platform in accordance with one or more example arrangements. Referring to FIG. 2A, at step 201, the OCR evaluation platform 102 may generate a script for evaluating performance of OCR applications. The script may be configured to output metric scores based on comparing original resources (e.g., scanned documents, text files, charts, video files, audio files, data tables, and/or other digital resources) and modified resources (e.g., original resources that have been modified by an OCR application). For example, the OCR evaluation platform 102 may generate a script configured to evaluate performance of OCR applications by taking input of original resources and modified resources, comparing the original resources and modified resources, and outputting metric scores based on the comparison. In some instances, the OCR evaluation platform 102 may generate the script based on user input. For example, the OCR evaluation platform 102 may receive user input from a user (e.g., an employee of an enterprise organization, and/or other users) causing the OCR evaluation platform 102 to code the script, execute a script generation program, and/or otherwise generate the script. Additionally or alternatively, in some instances, the OCR evaluation platform 102 may automatically generate the script without the need for user input. For example, OCR evaluation platform 102 may have previously installed (e.g., at internal memory, such as memory 112, and/or other memory) a computer program, application, protocol, and/or other computer feature configured to cause automatic script generation. In some examples, the OCR evaluation platform 102 may continuously or periodically generate and/or update scripts for evaluating performance of OCR applications.

At step 202, the OCR evaluation platform 102 may establish a connection with resource repository 104. For example, OCR evaluation platform 102 may establish a first wireless data connection with the resource repository 104 to link the resource repository 104 with the OCR evaluation platform 102 (e.g., in preparation for retrieving resources, storing correlations, and/or other functions). In some instances, the OCR evaluation platform 102 may identify whether or not a connection is already established with the resource repository 104. If a connection is already established with the resource repository 104, the OCR evaluation platform 102 might not re-establish the connection. For example, in some instances, the resource repository 104 may be a component of OCR evaluation platform 102 (e.g., as part of OCR evaluation database 112c) and/or otherwise included in OCR evaluation platform 102. In these instances, OCR evaluation platform 102 might not establish the first wireless data connection, because OCR evaluation platform 102 would already be connected to resource repository 104. If a connection is not yet established with the resource repository 104, the OCR evaluation platform 102 may establish the first wireless data connection as described above.

At step 203, the OCR evaluation platform 102 may retrieve an original resource (e.g., scanned documents, text files, charts, video files, audio files, data tables, and/or other digital resources) from the resource repository 104. In some instances, in retrieving the original resource, the OCR evaluation platform 102 may send one or more commands to the resource repository 104. The one or more commands may cause the resource repository 104 to send the original resource to the OCR evaluation platform 102. In some instances, the OCR evaluation platform 102 may send the one or more commands based on receiving user input directing the OCR evaluation platform 102 to retrieve the original resource (e.g., for OCR evaluation, and/or for other purposes). Additionally or alternatively, in some examples, the OCR evaluation platform 102 may be configured to automatically retrieve original resources. For example, an individual associated with OCR evaluation platform 102 (e.g., the employee of the enterprise organization associated with OCR evaluation platform 102, and/or other individuals) may have previously installed software (e.g., a computer program, an application, and/or other software) on OCR evaluation platform 102 causing the OCR evaluation platform 102 to continuously or periodically perform the functions for evaluating OCRs described herein. For example, the OCR evaluation platform 102 may continuously or periodically retrieve original resources and execute the script (e.g., as described above at step 201) to evaluate one or more OCR applications. In these examples, based on the software, the OCR evaluation platform 102 may automatically retrieve the original resource.

At step 204, the OCR evaluation platform 102 may generate a plurality of modified resources. In generating the modified resources, the OCR evaluation platform 102 may execute a plurality of OCR applications using the original resource such that each OCR application performs OCR operations (e.g., converting typed images into machine-readable text, converting handwritten images into machine readable text, converting printed text into machine-readable text, and/or other OCR operations) on the original resource and generates a unique modified resource corresponding to the particular OCR application. A modified resource may be of the same file type (e.g., text file, audio file, video file, portable document format (pdf) file, and/or other file types) as the original resource. In some instances, in generating the plurality of modified resources, the OCR evaluation platform 102 may first perform preprocessing operations on the original resource. For example, the OCR evaluation platform 102 may replace null characters detected in the original resource with blanks, convert columns of tables into a character type, and/or perform other preprocessing operations. In some examples, the preprocessing operations may be performed automatically by the OCR application.

Referring to FIG. 2B, at step 205, the OCR evaluation platform 102 may generate comparative analysis information. For example, the OCR evaluation platform 102 may generate comparative analysis information for each OCR application used to generate the plurality of modified resources (e.g., as described above at step 204). The comparative analysis information for each OCR application may be generated by comparing the original resource to the modified resource corresponding to each OCR application. For example, two OCR applications may have been executed using the original resource, resulting in two modified resources (one generated by the first OCR application and one generated by the second OCR application). The OCR evaluation platform 102 may generate a first set of comparative analysis information, corresponding to the first OCR application, by comparing the first modified resource to the original resource (e.g., to identify discrepancies between text and/or images of the original resource and text and/or images of the modified resource). The OCR evaluation platform 102 may then generate a second set of comparative analysis information, corresponding to the second OCR application, by comparing the second modified resource to the second modified resource. While two OCR applications resulting in two modified resources are described, additional OCR applications may be executed on the original resource resulting in additional modified resources and respective comparative analysis information. In some instances, the comparative analysis information may be and/or include raw data indicating the results of comparing the original resource to a modified resource (e.g., a number of detected, discrepancies, an identification of each detected discrepancy, and/or other data).

In generating the comparative analysis information, the OCR evaluation platform 102 may execute the script generated at step 201. For example, the OCR evaluation platform 102 may execute the script at least once for each OCR application used to generate a modified resource of the plurality of modified resources (e.g., each OCR application being evaluated). In executing the script at least once for each OCR application, the OCR evaluation platform 102 may further perform additional functions caused by execution of the script, such as: generating metric scores, generating weighted scores, generating visual representations, automatically selecting an OCR application, storing correlations, and/or other functions for providing improved OCR using automatic metric-based evaluations (e.g., as described below at steps 206-214). In some examples, the OCR evaluation platform 102 may execute the script automatically after generating the modified resources (e.g., based on source code in the script causing the script to be executed when an OCR application is used to generate a modified resource, and/or by other methods).

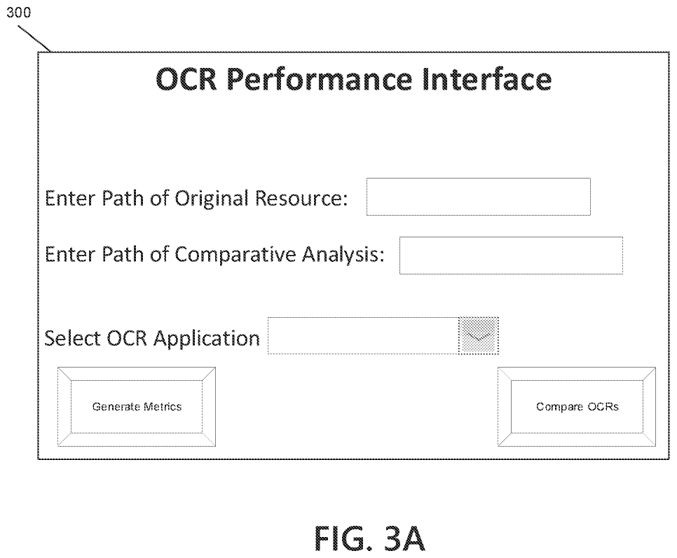

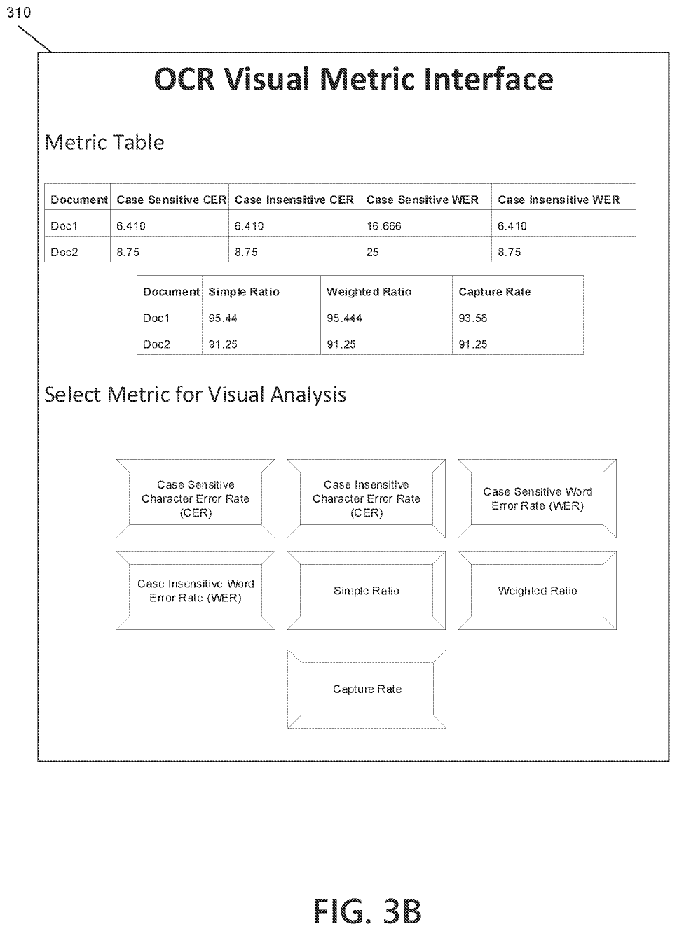

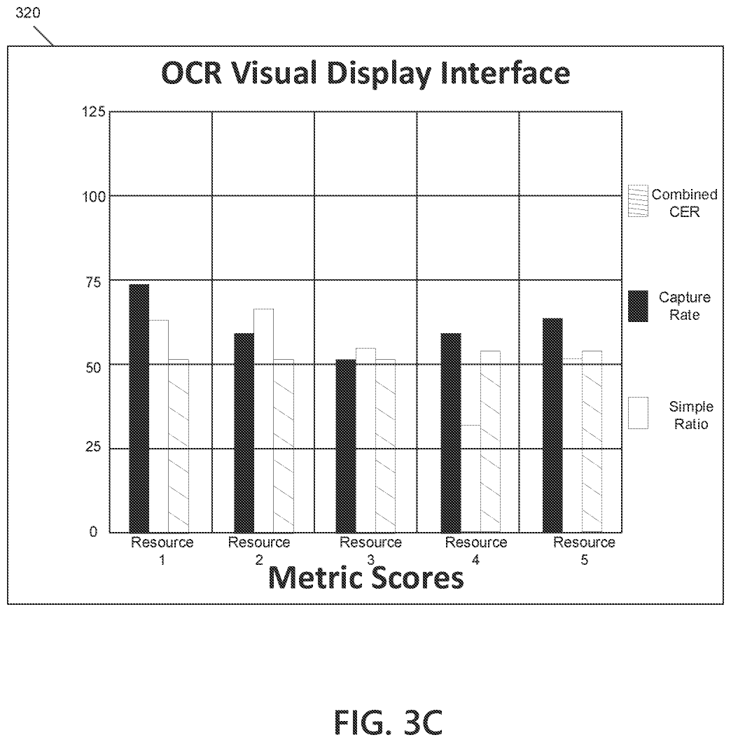

In some instances, in executing the script, the OCR evaluation platform 102 may cause display of an interface for providing improved OCR using automatic metric-based evaluations, such as an OCR performance interface configured to assist in generating comparative analysis information and/or generating metric scores (e.g., as described below at step 206). For instance, in displaying the OCR performance interface, the OCR evaluation platform 102 may display a graphical user interface similar to OCR performance interface 300, which is illustrated in FIG. 3A. Referring to FIG. 3A, in some instances, the OCR performance interface 300 may include display interface elements or selectable options requesting user input. For example, the OCR performance interface 300 may display one or more of: an information entry field, a button or buttons, toggle or toggles, check box or boxes, and/or other interface elements. For example, as illustrated in FIG. 3A, the interface elements may include an information entry field for entering the path of an original resource, and information entry field for entering the path of comparative analysis, an information entry field and/or dropdown for selecting an OCR application, a button and/or toggle for generating metrics and/or metric scores, a button and/or toggle for comparing OCRs, and/or other interface elements.

In some instances, based on user input providing the path of an original resource, the OCR evaluation platform 102 may identify a file location of the original resource (e.g., in memory 112, and/or other storage). In some examples, based on user input providing a path of comparative analysis, the OCR evaluation platform 102 may identify a storage location to store comparative analysis information once generated. In some instances, based on user input selecting an OCR application, the OCR evaluation platform 102 may identify an OCR application to use in generating a particular set of comparative analysis information. In some examples, based on user input to generate metrics and/or metric scores, the OCR evaluation platform 102 may generate one or more metric scores for a given OCR application (e.g., as described below at step 206). In some instances, based on user input to compare OCRs, the OCR evaluation platform 102 may generate comparative analysis information for one or more OCR applications (e.g., as described above at step 205).

Referring back to FIG. 2B, at step 206, the OCR evaluation platform 102 may generate one or more metric scores for each OCR application being evaluated, based on the comparative analysis information generated for each OCR application (e.g., as described above at step 205). In some instances, the OCR evaluation platform 102 may generate the one or more metric scores for each OCR application automatically, based on execution of the script. In some examples, the OCR evaluation platform 102 may generate the one or more metric scores for each OCR application based on user input (e.g., user input to an OCR performance interface, such as OCR performance interface 300, as described above with respect to FIG. 3A, and/or other user input).

In generating the one or more metric scores, the OCR evaluation platform 102 may generate metric scores such as, for example, case sensitive character error rate (such as a count of the minimum number of transforms needed transform all mistranslated characters in a modified resource that takes into account the case (e.g., uppercase or lowercase) of a character), case insensitive character error rate (such as a count of the number of the minimum number of transforms needed to transform all mistranslated characters in a modified resource that does not take into account the case), case sensitive word error rate (such as a count of the number of words including mistranslated characters in a modified resource that takes into account the case (e.g., uppercase or lowercase) of a character), case insensitive word error rate (such as a count of the number of words including mistranslated characters in a modified resource that does not take into account the case), simple Levenshtein ratio (such as a ratio of the number of differences between two strings, including punctuation), weighted ratio (e.g., using fuzzy matching, and/or other methods of weighting a ratio), capture rate (which may, e.g., be calculated by subtracting the character error rate from the number one hundred), and/or other metric scores may be generated and used in the evaluation of a respective OCR application. The OCR evaluation platform 102 may generate the one or more metric scores by mining, processing, and/or otherwise analyzing the comparative analysis information generated for each OCR application (e.g., as described above at step 205). For example, the OCR evaluation platform 102 may mine comparative analysis information for a given OCR application to identify, e.g., the sum of the Levenshtein distance(s) for each string of the modified resource, and/or other comparative analysis information relevant to a particular performance metric

Each metric score generated by the OCR evaluation platform 102 may be a value (e.g., an integer value, a percentage value, a decimal value, a fractional value, and/or any other value) associated with a particular performance metric. For example, each metric score may be a value associated with a performance metric such as a Levenshtein distance. “Levenshtein distance” may be defined as a number of changes (e.g., removal, addition, substitution, etc.) required to turn one string of text (e.g., text recognized using OCR) into another. For example, the Levenshtein distance between the strings “example” and “oxamples” would be two. A low Levenshtein distance between a string in the original resource and a string in a modified resource may indicate a better performance of an OCR application than a high Levenshtein distance. For example, if the original resource includes a string “example,” and a modified resource generated by a first OCR application converted the string to “oxamples” (Levenshtein distance=2), the first OCR application would have performed better in applying OCR to the string “example” than a second OCR application that generated a modified resource with the string “oxemples” (Levenshtein distance=3).

In some examples, the number and/or type of metric scores generated for each OCR application being evaluated may be based on settings and/or configurations determined by a user (e.g., the user of OCR evaluation platform 102, and/or other users). Additionally or alternatively, in some instances, the number and/or type of metric scores generated for each OCR application may be a predetermined value which may, e.g., be encoded in the script used to generate the one or more metric scores.

At step 207, the OCR evaluation platform 102 may generate a plurality of visual representations of the metric scores generated at step 206. For example, the OCR evaluation platform 102 may generate a plurality of visual representations using the script (which may, e.g., be and/or include code configured to cause generation of visual representations) and based on the one or more metric scores generated for each OCR application being evaluated. In some instances, in generating the plurality of visual representations for each OCR application, the OCR evaluation platform 102 may generate a different visual representation for each corresponding metric score for a respective OCR application (e.g., a visual representation for character sensitive error rate, a visual representation for capture rate, or the like). In some examples, in generating the plurality of visual representations for each OCR application, the OCR evaluation platform 102 may generate a one or more visual representations that combine one or more metric scores. In some instances, the OCR evaluation platform 102 may generate the plurality of visual representations automatically, e.g., by executing the script as described above at step 205. In some examples, the OCR evaluation platform 102 may generate the plurality of visual representations based on user input (e.g., user input received via an OCR visual representation interface, as described further below with respect to FIGS. 3B and 3C).

In some instances, in generating the plurality of visual representations, the OCR evaluation platform 102 may generate one or more interfaces that may be and/or include one or more visual representations. Based on generating the one or more interfaces, in some examples, the OCR evaluation platform 102 may output the visual representations via the interfaces (e.g., as described below at step 208). In some instances, the OCR evaluation platform 102 might not output the visual representations. In these instances, the OCR evaluation platform 102 might not perform the functions described at step 208 below, and might instead proceed to step 209.

At step 208, the OCR evaluation platform 102 may output one or more visual representations generated by the OCR evaluation platform 102. In some instances, the OCR evaluation platform 102 may automatically output the one or more visual representations based on executing the script. In some examples, the OCR evaluation platform 102 may output the one or more visual representations based on receiving user input to output the one or more visual representations (e.g., user input received via an OCR performance interface, such as OCR performance interface 300, as described above at step 205, and/or other user input). In some instances, in outputting the one or more visual representations, the OCR evaluation platform 102 may cause display of one or more OCR visual interfaces on a display of OCR evaluation platform 102. For example, the OCR evaluation platform 102 may cause display of an OCR visual metric interface, an OCR visual display interface, and/or other OCR visual interfaces on a display of OCR evaluation platform 102. A given OCR visual interface may correspond to a particular OCR application, of the plurality of OCR applications being evaluated.

For instance, in displaying the OCR visual interface, the OCR evaluation platform 102 may display a graphical user interface similar to OCR visual metric interface 310, which is illustrated in FIG. 3B. Referring to FIG. 3B, in some instances, the OCR visual metric interface 310 may include information related to the metric scores of a particular OCR application. For example, as illustrated in FIG. 3B, the OCR visual metric interface 310 may include a metric table and/or other representation of the OCR application's performance and metric scores for one or more metrics, a list of which original resources the OCR application was executed to perform OCR operations upon, and a listing of the metrics for which metric scores were generated.

Additionally or alternatively, in some instances, the OCR visual metric interface 310 may include display interface elements or selectable options requesting user input. For example, the OCR visual metric interface 310 may display one or more of: an information entry field, a button or buttons, toggle or toggles, check box or boxes, and/or other interface elements. For example, as illustrated in FIG. 3B, the interface elements may include a button and/or toggle for displaying and/or generating a visual analysis for one or more metrics (which may, e.g., cause display of an interface, such as OCR visual display interface 320, illustrated at FIG. 3C), and/or other interface elements.

Referring back to FIG. 2B and step 208, in displaying the OCR visual interface, the OCR evaluation platform 102 may display a graphical user interface similar to OCR visual display interface 320, which is illustrated in FIG. 3C. Referring to FIG. 3C, in some instances, the OCR visual display interface 320 may include information related to the metric scores of a particular OCR application. In some instances, the information may include some or all of the information included in an OCR visual metric interface (e.g., OCR visual metric interface 310, and/or other interfaces) presented in a different format For example, as illustrated in FIG. 3C, the OCR visual metric interface 320 may include a visual representation, such as a graph and/or other representation, of the OCR application's performance and metric scores for one or more metrics, an indication of which original resources the OCR application was executed to perform OCR operations upon, and a listing of the metrics for which metric scores were generated.

Referring back to FIG. 2B and step 208, in some instances the OCR evaluation platform 102 may automatically cause display of the one or more visual interfaces. For example, the OCR evaluation platform 102 may automatically cause display of OCR visual metric interface 310, OCR visual display interface 320, and/or other visual interfaces in response to generating the one or more metric scores and without receiving user input. Additionally or alternatively, in some examples, the OCR evaluation platform 102 may cause display of one or more visual interfaces. For example, the OCR evaluation platform 102 may cause display of a visual interface in one format (e.g., OCR visual display interface 320, or the like) based on receiving user input via a visual interface in a different format (e.g., OCR visual metric interface 310, or the like).

Referring to FIG. 2C, at step 209, the OCR evaluation platform 102 may generate weighted scores based on a plurality of metric scores (e.g., the plurality of metric scores generated at step 206 above). The OCR evaluation platform 102 may generate a weighted score for each OCR application being evaluated, based on the corresponding plurality of metric scores for each OCR application. In some examples, in generating the weighted scores, the OCR evaluation platform 102 may apply multipliers to one or more metric scores to generate weighted metric scores. The multipliers may be determined by a ranking (e.g., a tiered list, a chart, a graph, and/or other rankings) indicating the value of different metrics to an entity (e.g., an enterprise organization an employee of an enterprise organization, and/or other entities). In some instances, the ranking may be included in the script and the multipliers may be applied automatically, e.g., based on execution of the script. In some examples, the ranking may be determined based on user input providing a ranking of a plurality of metric scores and/or instructing the OCR evaluation platform 102 to apply particular multipliers to particular metric scores. The OCR evaluation platform 102 may generate the weighted score for each OCR application by summing some or all of the weighted metric scores and some or all of the unweighted metric scores (e.g., metric scores to which the OCR evaluation platform 102 did not apply a multiplier) for a given OCR application. In some instances, the weighted scores for each OCR application may correspond to a particular file type. For example, the weighted scores may include an indicator identifying that the weighted scores correspond to the file type of the original resource.

At step 210, the OCR evaluation platform 102 may identify an OCR application, of the plurality of OCR applications being evaluated, as the preferred OCR application for an operation. For example, the OCR evaluation platform 102 may identify the preferred OCR application as being preferred for performing OCR operations on a particular type of resource (e.g., the type and/or format of resource corresponding to the original resource, such as scanned documents, text files, charts, video files, audio files, data tables, portable document format files (PDFs), and/or other digital resources). In identifying the preferred OCR application, the OCR evaluation platform 102 may compare the weighted scores of each OCR application being evaluated. For example, the OCR evaluation platform 102 may determine that a first OCR application corresponds to a weighted score that exceeds weighted scores corresponding to one or more additional OCR applications. Accordingly, the OCR evaluation platform 102 may identify the first OCR application as the preferred OCR application for performing OCR operations on resources of the same type as the original resource used to evaluate (e.g., by performing the functions described herein at steps 201-209) the first OCR application and the one or more additional OCR applications. In some examples, the OCR evaluation platform 102 may be configured to automatically identify the preferred OCR application based on comparing the weighted scores of the plurality of OCR applications. In some instances, the OCR evaluation platform 102 may be configured to identify the preferred OCR application based on user input identifying the preferred OCR application.

At step 211, based on identifying the preferred OCR application, the OCR evaluation platform 102 may store a correlation between the preferred OCR application and the corresponding operation (e.g., performing OCR operations on the type and/or format of resource corresponding to the original resource, such as scanned documents, text files, charts, video files, audio files, data tables, portable document format files (PDFs), and/or other digital resources). In some instances, the OCR evaluation platform 102 may store the correlation to a remote resource repository (e.g., resource repository 104, and/or other remote resource repositories). Additionally or alternatively, in some examples, the OCR evaluation platform 102 may store the correlation to internal memory of OCR evaluation platform 102 (e.g., 112, and OCR evaluation database 112c) and/or external memory.

In some instances, in storing the correlation, the OCR evaluation platform 102 may cause the stored correlation to be accessible to user devices (e.g., enterprise device 106, and/or other user devices). Accordingly, the OCR evaluation platform 102 may further cause one or more user devices (e.g., enterprise device 106, and/or other user devices) to execute the preferred OCR application when performing the corresponding operation, based on the stored correlation (e.g., as described below at steps 212-213).

At step 212, the OCR evaluation platform 102 may establish a connection with enterprise device 106. For example, OCR evaluation platform 102 may establish a second wireless data connection with the enterprise device 106 to link the enterprise device 106 with the OCR evaluation platform 102 (e.g., in preparation for causing execution of a preferred OCR application, and/or other functions). In some instances, the OCR evaluation platform 102 may identify whether or not a connection is already established with the enterprise device 106. If a connection is already established with the enterprise device 106, the OCR evaluation platform 102 might not re-establish the connection. If a connection is not yet established with the enterprise device 106, the OCR evaluation platform 102 may establish the second wireless data connection as described above.

Referring to FIG. 2D, at step 213, the OCR evaluation platform 102 may cause execution of a preferred OCR application (e.g., the preferred OCR application identified at step 210, as described above, and/or other preferred OCR applications). In causing the execution, the OCR evaluation platform 102 may cause the execution of the preferred OCR application in order to perform a corresponding OCR operation, based on the stored correlation. For example, the OCR evaluation platform 102 may receive a request (e.g., from a user, such as an employee of the enterprise organization, and/or other users) to perform a particular OCR operation (e.g., performing OCR on a particular file type, and/or other OCR operations) and may access the stored correlation to identify the preferred OCR application for performing the particular OCR operation. Additionally or alternatively, in some examples, the OCR evaluation platform 102 may cause the execution of a plurality of preferred OCR applications. For example, the OCR evaluation platform 102 may receive requests (e.g., from a user, such as an employee of the enterprise organization, and/or other users) to perform a first OCR operation on a resource corresponding to a first file type and to perform a second OCR operation on a resource corresponding to a second file type. Accordingly, the OCR evaluation platform 102 may, based on stored correlations (which may, e.g., have been stored based on performing the functions for evaluating OCRs previously described herein at steps 201-211), execute a first OCR application to perform the first operation and execute a second OCR application, different from the first OCR application, to perform the second operation. Accordingly, the OCR evaluation platform 102 may optimize the use of OCR applications by executing the preferred OCR application for any given OCR operation, which may improve the efficiency of OCR operations (e.g., by generating modified resources with a minimum number of errors).

Additionally or alternatively, in some examples, the OCR evaluation platform 102 may cause execution of a preferred OCR application by a user device different from the OCR evaluation platform 102 (e.g., enterprise device 106, and/or other user devices). For example, in some instances, the OCR evaluation platform 102 may send (e.g., via the communication interface 113 and while the second wireless data connection is established) one or more instructions to other user devices (e.g., enterprise device 106, and/or other user devices) directing the other user devices to execute the preferred OCR application when performing a corresponding OCR operation. The instructions may cause the other user devices to access one or more stored correlations when performing OCR operations and execute the corresponding preferred OCR applications based on the stored correlations. Accordingly, the OCR evaluation platform 102 may optimize the use of OCR applications across a network of user devices.

At step 214, the OCR evaluation platform 102 may enhance a modified resource. For example, the OCR evaluation platform 102 may enhance a modified resource generated by a particular OCR application that was not identified as the preferred OCR application. In these examples, the OCR evaluation platform 102 may enhance the modified resource based on receiving user input (e.g., from an employee of an enterprise organization, and/or other users) instructing the OCR evaluation platform 102 to enhance the modified resource. In enhancing the modified resource, the OCR evaluation platform 102 may execute one or more image enhancement methods (e.g., an image enhancement application, such as a software program, and/or other image enhancement methods). Enhancing the modified resource may remove features of the modified resource that might cause errors in OCR applications (e.g., null characters, blurring, shadowing, and/or other features).

In some instances, based on enhancing the modified resource, the OCR evaluation platform 102 may evaluate one or more OCR applications again, using the enhanced modified resource and one or more modified resources (e.g., by performing the functions as described above with respect to steps 205-213). In some examples, in evaluating the one or more OCR applications again, the OCR evaluation platform 102 may identify the OCR application corresponding to the enhanced modified resource as the preferred OCR application, and may accordingly update one or more stored correlations. In some instances, the OCR evaluation platform 102 may repeat (e.g., automatically, or based on user input) the modified resource enhancement process and the OCR applications continuously or near-continuously, in order to refine and/or otherwise update the stored correlations. Accordingly, the OCR evaluation platform 102 may optimize the use of OCR applications by continuously or near-continuously evaluating OCR applications and identifying the preferred OCR application for performing any given OCR operation.

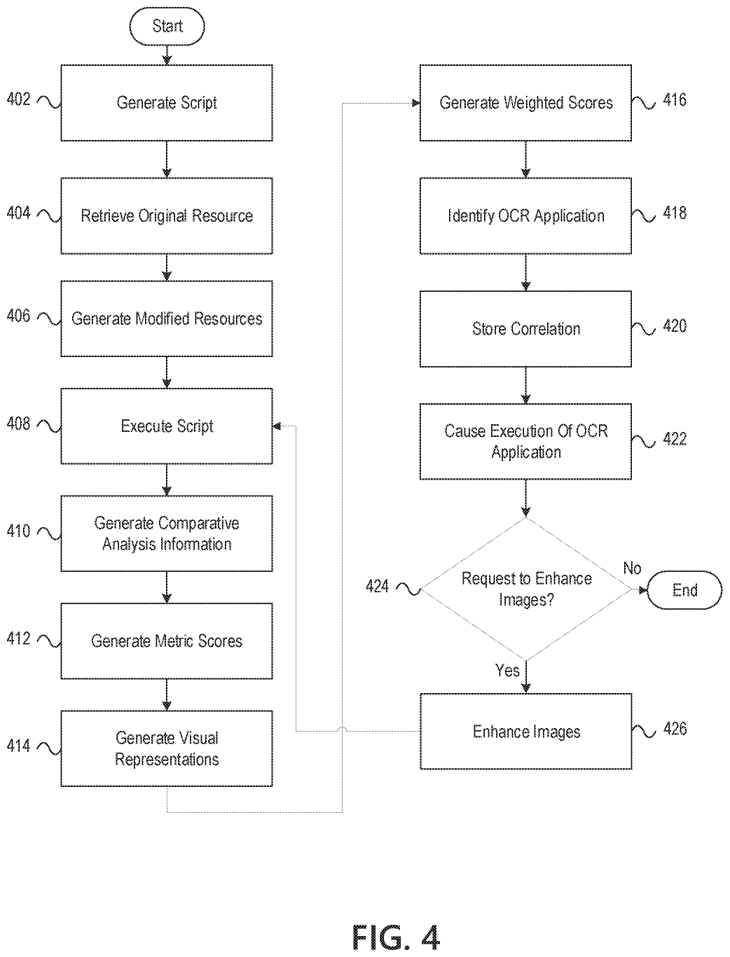

FIG. 4 depicts an illustrative method for providing improved optical character recognition using an automatic metric-based evaluation platform in accordance with one or more aspects described herein. Referring to FIG. 4, at step 402, a computing device having at least one processor, a communication interface, and memory may generate a script. For example, the computing device may generate a script for performing automatic metric-based evaluation of OCR applications. At step 404, the computing device may retrieve an original resource. At step 406, the computing device may generate one or more modified resources using one or more OCR applications (e.g., a first modified resource may be generated for a first OCR application and a second modified resource may be generated for a second OCR application different from the first OCR application). At step 408, the computing device may execute the script on each modified resource. For example, the computing device may execute the script for a first OCR application and a second OCR application. At step 410, the computing device may generate comparative analysis information for each OCR application (e.g., by comparing the original resource to each modified resource). For example, the computing device may generate first comparative analysis information for a first OCR application and second comparative analysis information for a second OCR application. At step 412, the computing device may generate metric scores for one or more metrics for a respective OCR application based on the comparative analysis information. For example, the computing device may generate one or more metric scores for a first OCR application based on first comparative analysis information and may generate one or more metric scores for a second OCR application based on second comparative analysis information. At step 414, the computing device may generate visual representations of each OCR application's performance based on the metric scores.

At step 416, the computing device may generate weighted scores based on the metric scores. For example, the computing device may generate a first weighted score based on one or more metric scores for the first OCR application and may generate a second weighted score based on one or more metric scores for the second OCR application. At step 418, the computing device may identify an OCR application as a preferred OCR application. For example, the computing device may identify the preferred OCR application as preferred for performing a particular OCR operation. At step 420, the computing device may store a correlation between the preferred OCR application and a particular OCR operation. At step 422, the computing device may cause execution of the preferred OCR application by one or more devices in response to a request to execute an OCR operation. At step 424, the computing device may identify whether a request to enhance images has been received. Based on identifying that a request to enhance images has been received, the computing device may proceed to step 426. Based on identifying that a request to enhance images has not been received, the computing device might not take further action. At step 426, based on identifying that a request to enhance images has been received, the computing device may enhance images. For example, the computing device may enhance images in a modified resource. Based on enhancing images, the computing device may return to step 408 and repeat steps 408-424.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
generate a script for evaluating performance of an optical character recognition (OCR) application, wherein the script is configured to output metric scores based on comparing original resources to modified resources;
retrieve an original resource from a resource repository;
generate a first modified resource by executing a first OCR application on the original resource;
generate a second modified resource by executing a second OCR application on the original resource, wherein the second OCR application is different from the first OCR application;
execute the script for the first OCR application and the second OCR application, wherein executing the script for first OCR application and the second OCR application includes:
generating first comparative analysis information for the first OCR application by comparing the original resource to the first modified resource;
generating second comparative analysis information for the second OCR application by comparing the original resource to the second modified resource;
generating, based on the first comparative analysis information, one or more metric scores for the first OCR application;
generating, based on the second comparative analysis information, one or more metric scores for the second OCR application;
generating, based on the one or more metric scores for the first OCR application, a first weighted score; and
generating, based on the one or more metric scores for the second OCR application, a second weighted score;
identify, based on comparing the first weighted score and the second weighted score, a preferred OCR application for use in a first operation; and
store a correlation between the first operation and the preferred OCR application at the resource repository.

2. The computing platform of claim 1, wherein the memory stores additional computer-readable instructions that, when executed by the at least one processor, cause the computing platform to:
enhance, based on a weighted score for a third OCR application and using at least one image-enhancement application, at least one modified resource corresponding to the third OCR application.

3. The computing platform of claim 1, wherein the memory stores additional computer-readable instructions that, when executed by the at least one processor, further cause the computing platform to:
generate, using the script and based on the one or more metric scores for the first OCR application, one or more visual representations for the first OCR application; and
output, for the first OCR application, at least one visual representation of the one or more visual representations in a first format.

4. The computing platform of claim 3, wherein the instructions, when executed by the at least one processor, further cause the computing platform to output, in a second format different from the first format and based on receiving user input, the at least one visual representation.

5. The computing platform of claim 1, wherein the first weighted score and the second weighted score correspond to a file type of the original resource.

6. The computing platform of claim 1, wherein the memory stores additional computer-readable instructions that, when executed by the at least one processor, cause the computing platform to:
cause, based on the stored correlation, at least one of:
execution, by the computing platform, of the preferred OCR application to perform the first operation, or
execution, by a user device different from the computing platform, of the preferred OCR application to perform the first operation.

7. The computing platform of claim 1, wherein the memory stores additional computer-readable instructions that, when executed by the at least one processor, cause the computing platform to:
receive a request to perform the first operation;
execute, based on the stored correlation, the preferred OCR application to perform the first operation;
receive a request to perform a second operation different from the first operation; and
execute a third OCR application different from the preferred OCR application to perform the second operation.

8. A method comprising:
at a computing device comprising at least one processor, a communication interface, and memory:
generating a script for evaluating performance of an optical character recognition (OCR) application, wherein the script is configured to output metric scores based on comparing original resources to modified resources;
retrieving an original resource from a resource repository;
generating a first modified resource by executing a first OCR application on the original resource;
generating a second modified resource by executing a second OCR application on the original resource, wherein the second OCR application is different from the first OCR application;
executing the script for the first OCR application and the second OCR application, wherein executing the script for first OCR application and the second OCR application includes:
generating first comparative analysis information for the first OCR application by comparing the original resource to the first modified resource;
generating second comparative analysis information for the second OCR application by comparing the original resource to the second modified resource;
generating, based on the first comparative analysis information, one or more metric scores for the first OCR application;
generating, based on the second comparative analysis information, one or more metric scores for the second OCR application;
generating, based on the one or more metric scores for the first OCR application, a first weighted score; and
generating, based on the one or more metric scores for the second OCR application, a second weighted score;
identifying, based on comparing the first weighted score and the second weighted score, a preferred OCR application for use in a first operation; and
storing a correlation between the first operation and the preferred OCR application at the resource repository.

9. The method of claim 8, further comprising:
at the computing device:
enhancing, based on a weighted score for a third OCR application and using at least one image-enhancement application, at least one modified resource corresponding to the third OCR application.

10. The method of claim 8, further comprising:
at the computing device:
generating, using the script and based on the one or more metric scores for the first OCR application, one or more visual representations for the first OCR application; and
outputting, for the first OCR application, at least one visual representation of the one or more visual representations in a first format.

11. The method of claim 10, wherein the outputting the at least one visual representation comprises outputting, in a second format different from the first format and based on receiving user input, the at least one visual representation.

12. The method of claim 8, wherein the first weighted score and the second weighted score correspond to a file type of the original resource.

13. The method of claim 8, further comprising:
at the computing device:
causing, based on the stored correlation, at least one of:
execution, by the computing device, of the preferred OCR application to perform the first operation, or
execution, by a user device different from the computing device, of the preferred OCR application to perform the first operation.

14. The method of claim 8, further comprising:
at the computing device:
receiving a request to perform the first operation;
executing, based on the stored correlation, the preferred OCR application to perform the first operation;
receiving a request to perform a second operation different from the first operation; and
executing a third OCR application different from the preferred OCR application to perform the second operation.

15. One or more non-transitory computer-readable media storing instructions that, when executed by a computing platform comprising at least one processor, a communication interface, and memory, cause the computing platform to:
generate a script for evaluating performance of an optical character recognition (OCR) application, wherein the script is configured to output metric scores based on comparing original resources to modified resources;
retrieve an original resource from a resource repository;
generate a first modified resource by executing a first OCR application on the original resource;
generate a second modified resource by executing a second OCR application on the original resource, wherein the second OCR application is different from the first OCR application;
execute the script for the first OCR application and the second OCR application, wherein executing the script for first OCR application and the second OCR application includes:
generating first comparative analysis information for the first OCR application by comparing the original resource to the first modified resource;
generating second comparative analysis information for the second OCR application by comparing the original resource to the second modified resource;
generating, based on the first comparative analysis information, one or more metric scores for the first OCR application;
generating, based on the second comparative analysis information, one or more metric scores for the second OCR application;
generating, based on the one or more metric scores for the first OCR application, a first weighted score; and
generating, based on the one or more metric scores for the second OCR application, a second weighted score;
identify, based on comparing the first weighted score and the second weighted score, a preferred OCR application for use in a first operation; and
store a correlation between the first operation and the preferred OCR application at the resource repository.

16. The one or more non-transitory computer-readable media of claim 15 storing instructions that, when executed, further cause the computing platform to:
enhance, based on a weighted score for a third OCR application and using at least one image-enhancement application, at least one modified resource corresponding to the third OCR application.

17. The one or more non-transitory computer-readable media of claim 15 storing instructions that, when executed, further cause the computing platform to:
generate, using the script and based on the one or more metric scores for the first OCR application, one or more visual representations for the first OCR application; and
output, for the first OCR application, at least one visual representation of the one or more visual representations in a first format.

18. The one or more non-transitory computer-readable media of claim 15, wherein the first weighted score and the second weighted score correspond to a file type of the original resource.

19. The one or more non-transitory computer-readable media of claim 15 storing instructions that, when executed, further cause the computing platform to:
cause, based on the stored correlation, at least one of:
execution, by the computing platform, of the preferred OCR application to perform the first operation, or
execution, by a user device different from the computing platform, of the preferred OCR application to perform the first operation.

20. The one or more non-transitory computer-readable media of claim 15 storing instructions that, when executed, further cause the computing platform to:
receive a request to perform the first operation;
execute, based on the stored correlation, the preferred OCR application to perform the first operation;
receive a request to perform a second operation different from the first operation; and
execute a third OCR application different from the preferred OCR application to perform the second operation.
